(19) United States
(12) Patent Application Publication
(10) Pub. No.: US 2008/0139280 A1
(43) Pub. Date: Jun. 12, 2008

(54) Roulette gaming machine and method for providing roulette game

(75) Inventor: Yukinori Inamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/979,850

(22) Filed: Nov. 8, 2007

(30) Foreign Application Priority Data
Nov. 14, 2006 (JP) 2006-307539

(51) Int. Cl. G07F 17/34

(52) U.S. Cl. 463/17

(57) ABSTRACT

A roulette gaming machine includes: a plurality of wheels that are provided with a plurality of number pockets having identification numbers assigned thereto; a plurality of balls that roll on an upper face of each of the wheels to be housed into one of the number pockets, respectively; a win number detecting unit that detects the identification numbers that are assigned to the number pockets into which the balls are housed as win numbers; a betting unit that allows a player to input a betting operation for performing a prediction of the win numbers as bet numbers; and a controller that operates to: determine a number of match between the bet numbers and the win numbers; determine a multiplication factor based on the number of match; and provide an award to the player when the number of match is larger than zero, the award having an amount calculated by multiplying a bet amount by the multiplication factor.

### CROSS-REFERENCE TO THE RELATED APPLICATION(S)

The present application is based upon and claims priority from prior Japanese Patent Application No. 2006-307539, filed on Nov. 14, 2006, the entire content of which are incorporated herein by reference.

### TECHNICAL FIELD

The present invention relates to a roulette gaming machine and a method for providing a roulette game, which provide a roulette game using a plurality of wheels, each of which being formed with a plurality of pockets thereon, the roulette game providing an award determined by win numbers of each of the wheels.

### BACKGROUND

In gaming machines that provides a game in which a player predicts win numbers, such as roulette gaming machines, bingo gaming machines, and keno gaming machines, there is provided a wheel that is formed with a plurality of pockets thereon having identification numbers are assigned (for example, “00”, “0”, and “1” to “36” in the roulette gaming machines), and the win numbers are determined by lotteries being performed by rolling a rolling object, such as a ball, on the wheel to determine a pocket in which the rolling object rolls in.

In the conventional gaming machines, a series of game flow, in which the ball is rolled on the wheel and the win number is determined, is basically common to all the games, and when a player plays the game repetitively, there occurs a problem that the player gradually becomes tired of playing the game.

A document, U.S. Pat. No. 6,921,072 B2, discloses a roulette gaming machine that is provided with a plurality of wheels and performs lotteries using each of the wheels. By performing a game using a plurality of wheels as described in the document, it becomes possible to give a player a change to obtain a high-valued award and improve a variety of the game by using a plurality of win numbers that have been drawn.

The conventional roulette gaming machine disclosed in the document, although uses a plurality of wheels, has the winning condition and details of awards that are used in other general gaming machines that use single wheel, except for a win of a lucky number. Accordingly, the game progresses in a manner that the player predicts a number at which the ball may stop on the roulette wheel and performs a bet by placing chips in a place on a table, and an award is provided on the basis of the win number and the betting operation.

### SUMMARY

One of objects of the present invention is to provide a roulette gaming machine and a method for providing a game that prevent the player from being tired of the game by changing the winning condition or the contents of the awards in various ways, while using the structure of the general wheel and general lottery method.

According to a first aspect of the invention, there is provided a gaming machine including: a plurality of wheels that are provided with a plurality of number pockets having identification numbers assigned thereto; a plurality of balls that roll on an upper face of each of the wheels to be housed into one of the number pockets, respectively; a win number detecting unit that detects the identification numbers that are assigned to the number pockets into which the balls are housed as win numbers; a betting unit that allows a player to input a betting operation for performing a prediction of the win numbers as bet numbers; and a controller that operates to: determine a number of match between the bet numbers and the win numbers; determine a multiplication factor based on the number of match; and provide an award to the player when the number of match is larger than zero, the award having an amount calculated by multiplying a bet amount by the multiplication factor.

According to a second aspect of the invention, there is provided a gaming machine including: a first wheel that is provided with a plurality of number pockets having identification numbers assigned thereto; a second wheel that is provided with a plurality of number pockets having identification numbers assigned thereto; a first ball that rolls on an upper face of the first wheel to be housed into one of the number pockets; a second ball that rolls on an upper face of the second wheel to be housed into one of the number pockets; a first win number detecting unit that detects the identification number that is assigned to the number pockets into which the first ball is housed as a first win number; a second win number detecting unit that detects the identification number that is assigned to the number pockets into which the second ball is housed as a second win number; a betting unit that allows a player to input a betting operation for performing a prediction of the first win number and the second win numbers as bet numbers; and a controller that operates to: determine that a first win is satisfied when one of the bet numbers matches with one of the first win number and the second win number; provide an award to the player when determined that the first win is satisfied, the award having an amount calculated by multiplying a bet amount by a first multiplication factor; determine that a second win is satisfied when the bet numbers match with both of the first win number and the second win number; and provide an award to the player when determined that the second win is satisfied, the award having an amount calculated by multiplying the bet amount by a second multiplication factor that is larger than the first multiplication factor.

According to a third aspect of the invention, there is provided a method for providing a roulette game to a player, the method including: determining identification numbers for each of a plurality of wheels respectively, as win numbers, from among a plurality of identification numbers assigned to a plurality of number pockets provided on the wheels; allowing the player to input a betting operation for performing a prediction of the win numbers as bet numbers; determining a number of match between the bet numbers and the win numbers; determining a multiplication factor based on the number of match; and providing an award to the player when the number of match is larger than zero, the award having an amount calculated by multiplying a bet amount by the multiplication factor.

According to a fourth aspect of the invention, there is provided a method for providing a roulette game, the method including: determining an identification number, as a first win number, from among a plurality of identification numbers assigned to a plurality of number pockets provided on a first wheel; determining an identification number, as a second win number, from among a plurality of identification numbers assigned to a plurality of number pockets provided on a second wheel; allowing the player to input a betting operation for performing a prediction of the first win number and the second win number as bet numbers; determine that a first win is satisfied when one of the bet numbers matches with one of the first win number and the second win number; provide an award to the player when determined that the first win is satisfied, the award having an amount calculated by multiplying a bet amount by a first multiplication factor; determine that a second win is satisfied when the bet numbers match with both of the first win number and the second win number; and provide an award to the player when determined that the second win is satisfied, the award having an amount calculated by multiplying the bet amount by a second multiplication factor that is larger than the first multiplication factor.

### BRIEF DESCRIPTION OF THE DRAWINGS

In the accompanying drawings:

FIG. 1 is a perspective view of a roulette gaming machine according to an embodiment of the present invention;

FIG. 2 is a plan view of a first roulette board according to the embodiment;

FIG. 3 is a plan view of a second roulette board according to the embodiment;

FIG. 4 is a perspective view of a server according to the embodiment;

FIG. 5 is a drawing that shows a BET screen displayed on a display;

FIG. 6 is a drawing that shows a list of awards including types of the awards and multiplication factors for the awards;

FIG. 7 is a schematic block diagram that shows a control system of the roulette gaming machine according to the embodiment;

FIG. 8 is a schematic block diagram that shows a control system of a station according to the embodiment;

FIG. 9 is a schematic drawing that shows a storage area of a ROM of the roulette gaming machine according to the embodiment;

FIG. 10 is a schematic drawing that shows a storage area of a RAM of the roulette gaming machine according to the embodiment;

FIG. 11 is a flowchart of a game processing program of the roulette gaming machine according to the embodiment; and

FIG. 12 is a flowchart of the game processing program of the roulette gaming machine according to the embodiment.

### DETAILED DESCRIPTION

Hereinafter, a roulette gaming machine according to an embodiment of the present invention will be described in detail with reference to the accompanying drawings. The roulette gaming machine is a gaming machine that provides a roulette game in which a player predicts a number or a symbol that is determined by a lottery performed by use of a roulette board, allows the player to bet a game medium such as medals on the predicted number, and provides a predetermined number of medals to the player when the bet number satisfies a win.

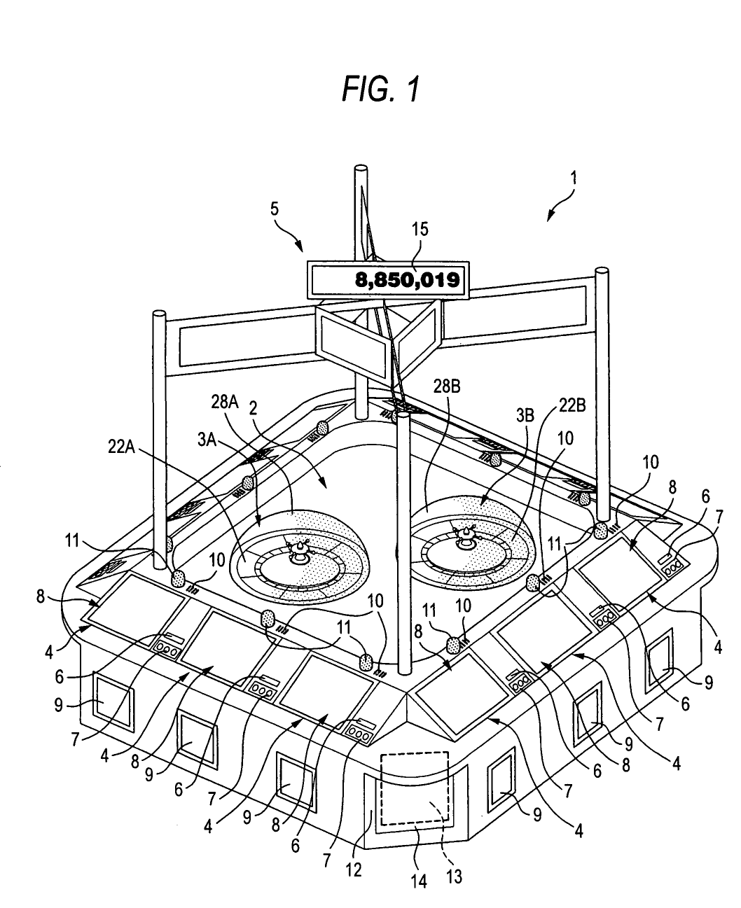

As shown in FIG. 1, the roulette gaming machine 1 according to the embodiment is provided with two wheels on which balls roll. The roulette gaming machine 1 simultaneously performs lotteries using balls on the wheels 22A and 22B, and thereby a total of two win numbers for the wheels 22A and 22B are detected. Then, the roulette gaming machine 1 compares a bet operation performed in each station 4 by a player with the two win numbers. When a bet number and the win numbers matches, an amount resulted from multiplying a bet amount by a multiplication factor that is set on the basis of the number of matched numbers is provided as an award.

First, a schematic configuration of the roulette gaming machine 1 according to the embodiment will be described with reference to FIG. 1. FIG. 1 is a perspective view of the roulette gaming machine 1 according to the embodiment.

As shown in FIG. 1, the roulette gaming machine 1 has a housing 2 forming a main frame, a plurality (in the embodiment, two) of roulette boards including first and second roulette boards 3A and 3B provided on the approximate center of the top face of the housing 2, a plurality of (in the embodiment, twelve) stations 4 installed around the first roulette board 3A and the second roulette board 3B so as to surround the first roulette board 3A and the second roulette board 3B, and an electronic display unit 5 provided above the housing 2, as basic components.

Each of the stations 4 serves as a betting unit that allows a player to input a betting operation that is performed on prediction of win numbers in the first roulette board 3A and the second roulette board 3B. The station 4 includes a medal insertion slot 6 for inserting game media such as coins or chips or medals which are used in a game, a controller unit 7 having a plurality of control buttons through which various commands for playing the game is input by the player, and a display 8 for displaying an image related with the game. The station 4 is a game area for receiving a betting operation from the player. The player operates a touch panel, the controller unit 7, or the like so as to progress the current game while watching the image displayed on the display 8.

On side faces of the housing 2 on which the stations 4 are installed, medal payout openings 9 are provided. On upper right sides of the displays 8 of the stations 4, speakers 10 for providing music and a sound effects are provided.

Above the displays 8 of the stations 4, WIN lamps 11 are provided. In a roulette game, when a bet number (in the embodiment, “00”, “0”, and “1” to “36”) bet in the station 4 wins the game, the WIN lamp 11 of the won station 4 is turned on. Similar to a bingo game to be described later, the WIN lamp 11 of the station 4 that acquires a jackpot (hereinafter, referred to as JP) is turned on. The WIN lamps are disposed in positions that can be seen from all the players seated in the installed stations 4 (in the embodiment, twelve stations), and other players participating in the same game provided by the roulette gaming machine 1 can check the lightening of the WIN lamps 11 of other players any time.

Inside the medal insertion slot 6, a medal sensor (not shown) is provided so as to identify game media such as medals inserted from the medal insertion slot 6 and to count the inserted medals. In addition, inside the medal payout opening 9, a hopper (not shown) is provided so as to pay a predetermined number of medals from the medal payout opening 9.

Inside a corner portion 12 located in a corner of the housing 2, a server 13 to be described later is disposed. Commonly, the server 13 is housed inside the corner portion 12 so as not to be operated by a player, and the server can be operated 13 by opening a corner door 14, which is located in the corner portion 12 using a key switch. It is possible to adjust various settings of the roulette gaming machine 1 by operating the server 13.

In the electronic display unit 5, a JP amount display section 15 for displaying the amount of a JP is provided. In the roulette gaming machine 1 according to the embodiment, 0.5% of credits bet in roulette games of the total twelve stations 4 using a BET screen 61, to be described later, are accumulated to be stored. The accumulated credits of the JP are paid to a predetermined station 4 when a predetermined condition is satisfied in a bonus game to be described later so as to win the JP. The JP amount display section 15 is provided on the top of the electronic display unit 5, and thereby the content of display thereof can be seen from all the players gaming at the stations 4.

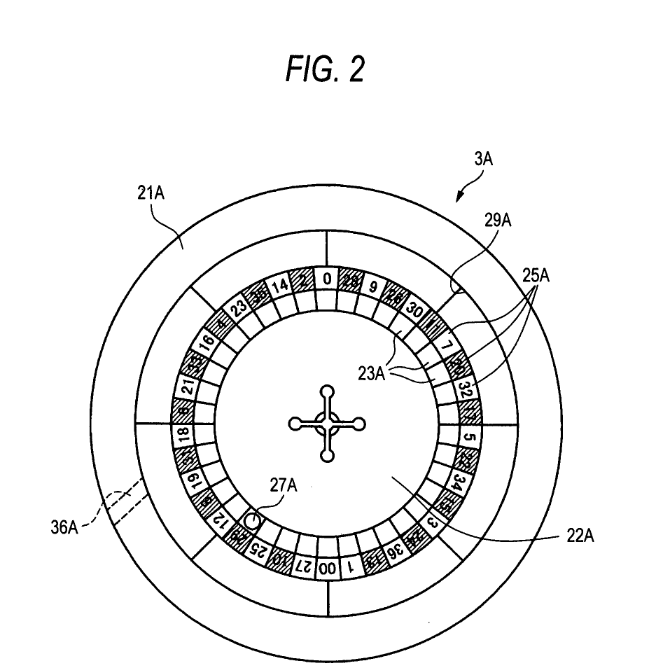

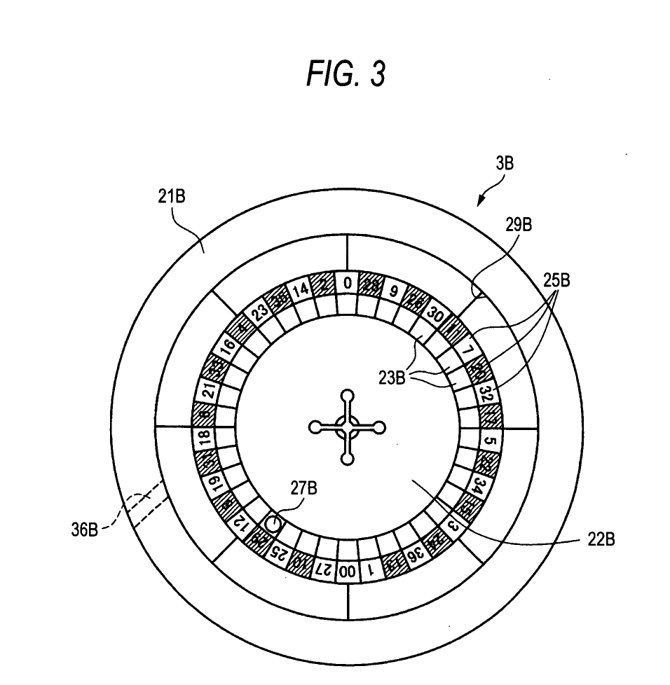

Next, the configurations of the first roulette board 3A and the second roulette board 3B according to the embodiment will be described. FIG. 2 is a plan view of the first roulette board 3A according to the embodiment, and FIG. 3 is a plan view of the second roulette board 3B according to the embodiment. Since the configuration of the first roulette board 3A and that of the second roulette board 3B are the same, hereinafter, only the configuration of the first roulette board 3A will be described as an example, and a description of the second roulette board 3B will be omitted here.

As shown in FIG. 2, the first roulette board 3A has a frame 21A fixed to the housing 2 and a wheel 22A inserted into and supported by an inside of the frame 21A to be rotatable, as basic components.

On an upper face of the wheel 22A, a plurality of (in the embodiment, total 38) number pockets 23A having a concaved shape are formed. In addition, on the upper face of the wheel 22A, number indication plates 25A on which numbers of “00”, “0”, and “1” to “36”, represented as graphic characters, corresponding to the number pockets 23A are marked are formed in an outer direction of the number pockets 23A. In other words, total 38 number pockets 23A each having one of numbers of “00”, “0”, and “1” to “36” assigned are formed with respect to the wheel 22A.

Inside the frame 21A, a ball discharge port 36A is formed. A ball discharge unit not shown in the figure is connected to the ball discharge port 36A such that a ball 27A is thrown on the wheel 22A from the ball discharge port 36A in accordance with driving the ball discharge unit. The whole upper side of the roulette board is covered with a cover member 28A that is made of transparent acryl and has a half-sphere shape.

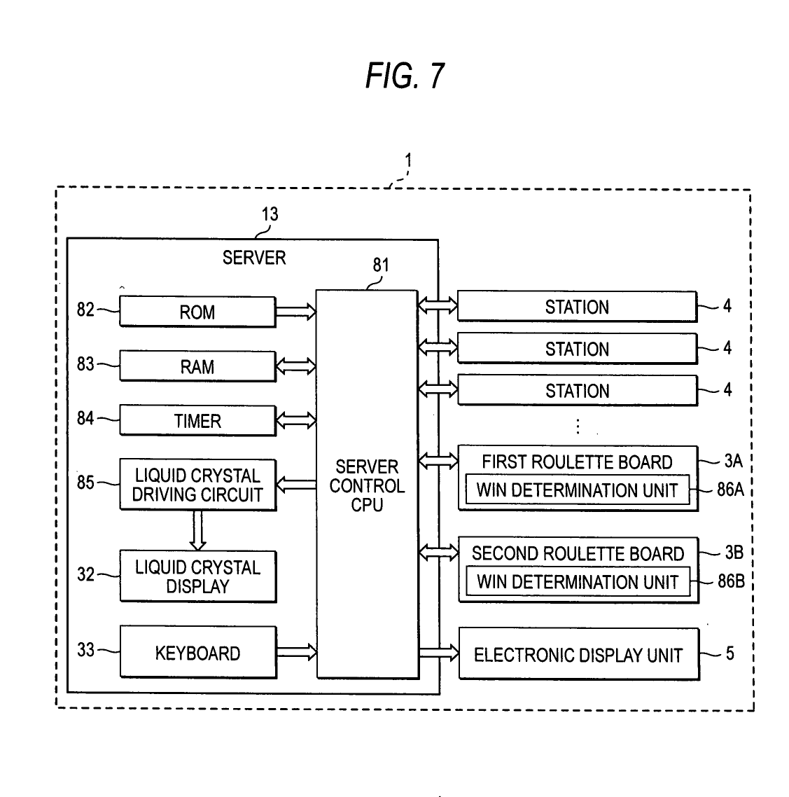

Below the wheel 22A, a win determination unit 86A (see FIG. 7) is installed. The win determination unit 86A is used for determining a number pocket 23A in which the ball 27A is housed. In addition, below the wheel 22A, a ball collection unit not shown in the figure is installed. The ball collection unit is used for collecting the ball 27A on the wheel 22A after each game is over. Since, the ball discharge unit, the win determination unit, and the ball collection unit are known in public, detailed descriptions thereof are omitted here.

The frame 21A is formed in a shape that gently inclines toward an inner portion thereof, and a guide wall 29A is formed in a middle portion thereof. The guide wall 29A guides the input ball 27A against the centrifugal force so as to roll the ball 27A. As the rotation speed of the wheel reduces and the centrifugal force decreases, the ball 27A rolls down the slope of the frame 21A, moves inward, and arrives at the rotating wheel 22.

Then, the ball 27A that rolled to the wheel 22A passes through the number indication plate 25A disposed in an outer portion the rotating wheel 22A and is housed in one of the number pockets 23A. Thus, when the ball 27A is housed in the number pocket 23A, a number marked on the number indication plate 25A corresponding to the number pocket 23A housing the ball is determined by the win determination unit 86A and becomes a win number.

The configurations of a frame 21B, a wheel 22B, a number pocket 23B, a number indication plate 25B, a ball 27B, a cover member 28B, a guide wall 29B, a ball discharge port 36B, and a win determination unit 86B which are included in the second roulette board 3B shown in FIG. 3 are the same as those of the frame 21A, the wheel 22A, the number pocket 23A, the number indication plate 25A, the ball 27A, the cover member 28A, the guide wall 29A, the ball discharge port 36A, and the win determination unit 86A which are included in the first roulette board 3A.

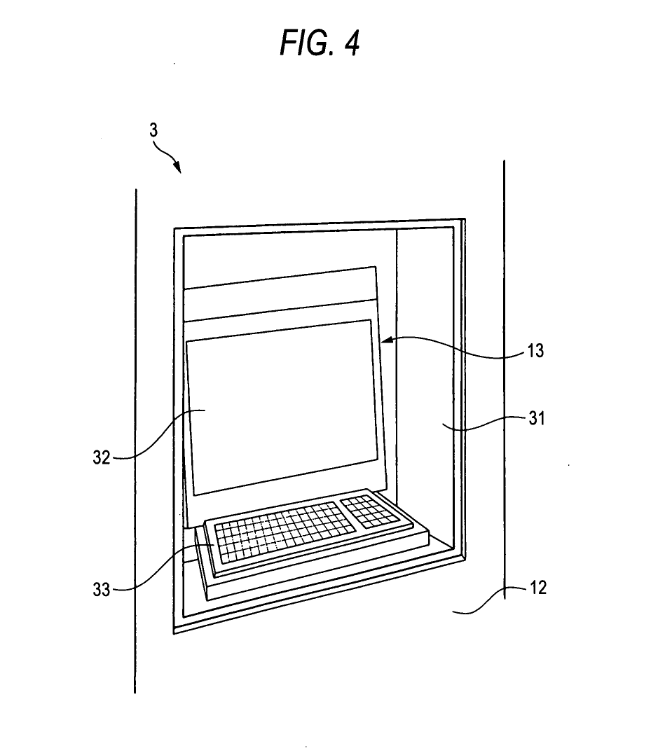

Next, a server 13 provided in the roulette gaming machine 1 according to the embodiment will be described with reference to FIG. 4. FIG. 4 is a perspective view of the server 13 according to the embodiment.

FIG. 4 is a drawing that shows a status in which the corner door 14 of the corner portion 12 is opened. The server 13 is installed in a space 31 formed in a wall of the housing 2.

The server 13 is connected to each of the stations 4. The server 13 controls the stations 4 for progressing games by sending command signals to the stations 4. The server 13 performs controls for maintenance of the roulette gaming machine 1 in addition to the control for games of the roulette gaming machine 1.

As shown in FIG. 4, a liquid crystal display 32 and a keyboard 33 are connected to the server 13. On the liquid crystal display 32, a menu screen (not shown) or a maintenance screen (not shown) is displayed. The keyboard 33 is an operation means in which a plurality of keys are arranged. The roulette gaming machine 1 allows a maintenance person to perform a maintenance operation and various setting operations by operating the keyboard 33 with the menu screen or the maintenance screen being displayed on the liquid crystal display 32.

Next, the configuration of the controller unit 7 and the display 8 according to the embodiment will be described.

The controller unit 7, as shown in FIG. 2, is provided on a side of the display 8. Various buttons operated by a player are disposed in the controller unit 7. In the controller unit 7, a BET confirmation button 47, a payout (CASHOUT) button 48, and a help (HELP) button 49 are sequentially arranged from the left, when viewed from a position facing the station 4.

The BET confirmation button 47 is pressed for confirming a bet after a betting operation is performed by using the display 8, as described later. When the bet is confirmed and if the player has placed a bet on a number marked on a number indication plate 25 corresponding to the number pockets 23A and 23B of the first and the second roulette boards 3A and 3B in which the balls 27A and 27B are housed during the game, the player wins the game. If the player wins the game, credits corresponding to the bet number of chips are added to the player's current credits. The betting operation will be described later in detail.

The payout button 48 is a button usually pressed when a game is over. When the payout button 48 is pressed, medals corresponding to the current credits of the player which have been acquired by the games (usually, one medal for each credit) are paid out to the player from the medal payout opening 9.

The help button 49 is a button pressed when the player is unfamiliar with a rule of the game. When the help button 49 is pressed, a help screen indicating various kinds of operation information are displayed on the display 8.

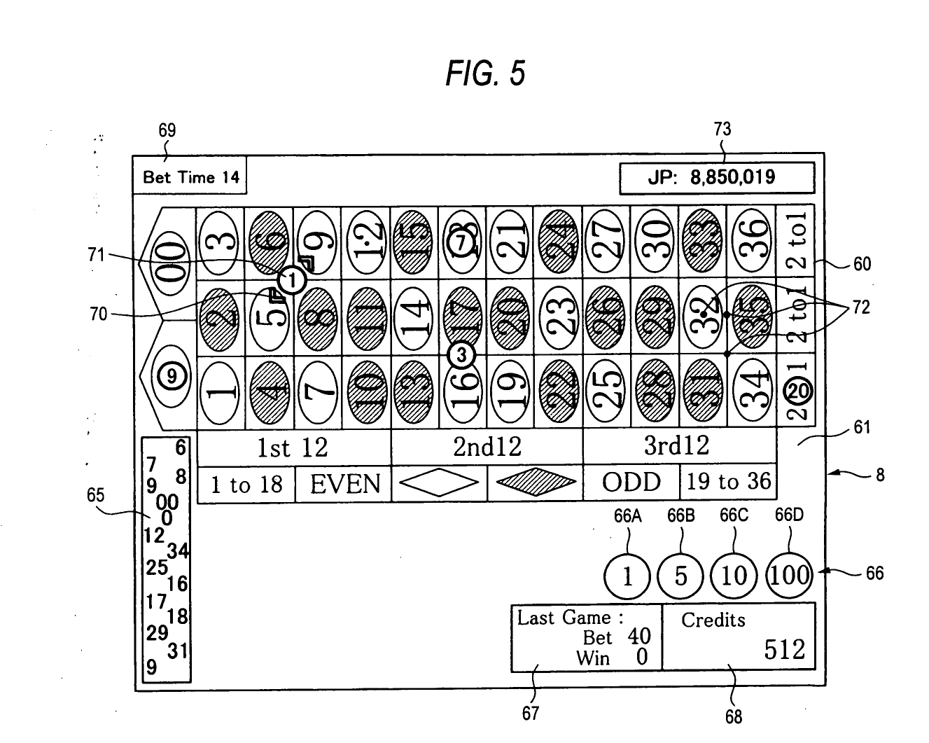

The display 8 is a touch-panel type liquid crystal display with a touch panel 50 attached to the front face thereof. The player presses an icon displayed on a liquid crystal screen with a finger when selecting the icon. FIG. 5 is a drawing showing an example of a display screen displayed on the display 8 during the game.

As shown in FIG. 5, while only a roulette game is performed in the roulette gaming machine 1, a BET screen 61, in which a table type betting board 60 is included, is displayed on the display 8. The player can bet chips using the credits owned by the player by operating the BET screen 61.

First, the BET screen 61, which is used when only the roulette game is performed, will be discussed with reference to FIG. 5. The same numbers as 38 numbers of “0”, “00”, and “1” to “36” are arranged in the shape of grids on the table type betting board 60 displayed on the BET screen 61. In addition, special BET areas for the player to bet a chip by designating “odd numbers,” “even numbers,” “a color (red or black) of the number indication plates”, or “a predetermined range of numbers (for example, “1” to “12” or the like)” are arranged similarly in the shape of grids.

Displayed below the table type betting board 60 are a result history display section 65, unit BET buttons 66, a payout result display section 67, and a credit count display section 68 from the left side to the right side in the screen.

The result history display section 65 displays a list of the results of the win numbers up to the previous game (here, one game refers to an operation sequence from when the player places a bet in each station 4 until when the balls 27A and 27B roll down into the number pockets 23A and 23B and credits are paid on the basis of the two win numbers). When one game is over, a new pair of win numbers is added to the top of the result history display section 65 for display and the player can check the history of the win numbers of a maximum of 10 games.

The unit BET buttons 66 are used for betting chips on a BET area 72 (on a grid or a line forming grids of a number or a mark) designated by the player. The unit BET buttons 66 include four types of buttons of a 1-BET button 66A, a 5-BET button 66B, a 10-BET button 66C, and a 100-BET button 66D.

The player first designates the BET area 72 to bet with a cursor 70 described later by directly pressing the screen with a finger. In this state, the player bets one chip at a time when the player presses the 1-BET button 66A (the number of bet chips sequentially increases from one to two, and from two to three, etc., each time the player presses the 1-BET button 66A with a finger). When the player presses the 5-BET button 66B, the player bets five chips at a time (the number of bet chips sequentially increases from five to ten, and from 10 to 15, etc., each time the player presses the 5-BET button 66B with a finger). When the player presses the 10-BET button 66C, the player bets 10 chips at a time (the number of bet chips sequentially increases from 10 to 20, and from 20 to 30, etc., each time the player presses the 10-BET button 66C with a finger). Similarly, when the player presses the 100-BET button 66D, the player can bet 100 chips at a time (the number of bet chips sequentially increases from 100 to 200, and from 200 to 300, etc., each time the player presses the 100-BET button 66D with a finger).

Therefore, even when a large number of chips are to be bet, the betting operation can be simplified.

The payout result display section 67 displays the number of bet chips of the player in the previous game and the number of paid-out credits. Here, subtracting the number of bet chips from the number of paid-out credits results in the number of credits that have been newly gained by the player in the previous game.

The credit count display section 68 displays the number of currents owned by the player. When the player bets chips, the number of credits is decreased by the number of the bet chips (one credit per chip). When the number on which the player bets becomes a win number and the credit is paid out, the number of credits is increased by the number of paid-out credits. When the number of credits owned by the player reaches zero, the game is over.

A BET timer display section 69 is provided in an upper portion of the table type betting board 60. The BET timer display section 69 displays the remaining time during which the player can bet. When reception for a betting operation is started, the BET timer display section 69 displays “20”. Then, the displayed number decreases by one per second, and when the displayed number becomes zero, the reception for the betting operation is over. When the remaining betting period becomes five seconds for each station 4, the ball discharge unit is driven to input the ball 27 on the roulette board.

On the right side of the BET timer display section 69, a JP display section 73 for displaying the current number of credits of the JP that have been accumulated is provided. In the JP, 0.5% of credits bet in the total 12 stations are added for accumulation and a number common to all the stations 4 is displayed in the JP display section 73 for each station 4. When a predetermined condition is satisfied in the bonus game that is performed in parallel with a roulette game under a predetermined condition, the JP is won. Thus, the credits corresponding to the number of credits of the JP are paid, and an initial value (for example, 50000 credits) is displayed in the JP display section after the payment. The current number of credits of the JP that has been accumulated is displayed in the JP amount display section 15 (see FIG. 1) of the electronic display unit 5 in addition to the JP display section 73.

A cursor 70 indicating the BET area 72 currently selected by the player is displayed on the table type betting board 30. A chip mark 71 indicating the number of chips bet so far and the BET area 72 is also displayed on the table type betting board 60. The number displayed on the chip mark 71 denotes the number of bet chips. For example, as shown in FIG. 5, the chip mark 71 of “7” placed on the grid of “18” indicates that the player bets seven chips on the number of “18”. As described above, the method of betting on only one number is called “straight bet.”

The chip mark 71 of “1” placed at the intersection of the grids of “5”, “6”, “8”, and “9” indicates that the player bets one chip on the four numbers covering the number of “5”, “6”, “8”, and “9”. As described above, the method of betting a chip covering four numbers is called “corner bet.”

Other available bet methods are as follows: “split bet” for betting a chip covering two numbers on a line between the two numbers; “street bet” for betting a chip covering three numbers (for example, “13”, “14”, and “15”) on the end of one horizontal row of the numbers (in FIG. 5, one row in the vertical direction); “five bet” for betting a chip covering five numbers of “0”, “00”, “1”, “2”, and “3” on a line between the numbers “00” and 3; “line bet” for betting a chip covering six numbers (for example, “13”, “14”, “15”, “16”, “17”, and “18”) in two horizontal rows of the numbers (in FIG. 5, two rows in the vertical direction); “column bet” for betting a chip on the grid marked as “2 to 1” for covering 12 numbers; and “dozen bet” for betting a chip on the grid marked as “1st 12,” “2nd 12,” or “3rd 12.” covering 12 numbers. Further, bet methods each covering 18 numbers depending on the color (red or black) of the number indication plates, whether the number is an odd or even number, or whether the number is equal to or less than 18 or is equal to or more than 19, using six grids provided at the bottom of the table type betting board 60 are also available. The above-described bet methods have different amounts of credit awards (award multiplication factor) per chip which are given in a state where the bet chips win the game. In the embodiment, it is configured that the award multiplication factor varies in accordance with a number of matches of the win numbers that is detected in a result of the lotteries performed by the two roulette boards 3A and 3B. The details of the award multiplication factor will be described later.

To bet a chip on the above-described BET screen 61, the player, first, designates a BET area 72 (on a grid of a number or a mark or a line forming the grid) to bet on the screen by pressing the BET area 72 directly with a finger. Consequently, the cursor 70 moves to the designated BET area 72.

Then, when the player presses the unit BET buttons 66 (the 1-BET button 66A, the 5-BET button 66B, the 10-BET button 66C, and the 100-BET button 66D), as many chips as the numbers indicated by the pressed unit BET buttons are bet on the designated BET area 72. For example, when the player presses the 10-BET button 66C four times, the 5-BET button 66B once, and the 1-BET button 66A three times, a total of 48 chips can be bet.

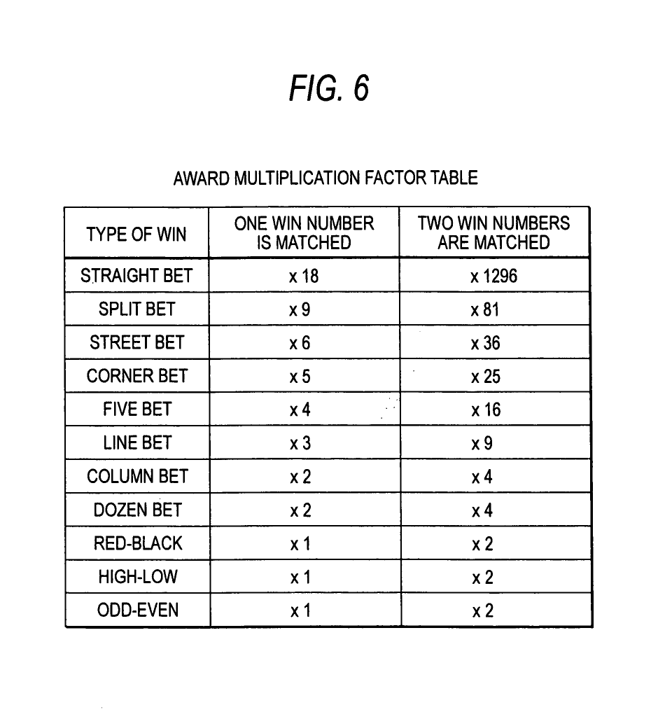

Next, the types of awards and a win multiplication factor of the roulette gaming machine 1 according to the embodiment will be described with reference to FIG. 6. FIG. 6 is a drawing that shows the types of awards and the win multiplication factor.

Generally, in a roulette gaming machine, a player wins an award when a number (includes an odd number, an even number, or the type of a color of the number indication plate) bet at a station 4 by a player and a win number (includes an odd number, an even number, or the type of a color of the number indication plate) of a roulette board are matched to each other, and in such a case, an amount resulted from multiplying a bet amount by an award multiplication factor, which is determined on the basis of a bet method (a straight bet, a corner bet, or the like) in advance, is provided as an award. However, in the roulette gaming machine 1 according to the embodiment, as shown in FIG. 6, the award multiplication factor also changes on the basis of the number of matched numbers between the number bet by the player and two win numbers detected by the wheels 22A and 22B.

For example, in a state where the “straight bet” method in which one number is bet is used, when the bet number is matched to one win number, an amount resulted from multiplying the bet amount by 18 is provided as an award. On the other hand, when the bet number is matched to the two win numbers, an amount resulted from multiplying the bet amount by 1296 is provided as an award.

In a state where a column bet method in which a bet for covering 12 numbers is placed is used, when one of the bet 12 numbers is matched to one win number, an amount resulted from multiplying the bet amount by two is provided as an award. On the other hand, when the bet numbers are matched to the two win numbers, an amount resulted from multiplying the bet amount by four is provided as an award.

Next, the configuration of a control system of the roulette gaming machine 1 according to the embodiment will be described with reference to FIG. 7. FIG. 7 is a block diagram schematically showing the control system of the roulette gaming machine 1.

As shown in FIG. 7, the roulette gaming machine 1 includes a server 13 and a plurality of (12 in the embodiment) stations 4 connected to the server 13. To the server 13, first and second roulette boards 3A and 3B and an electronic display unit 5 are connected. A control system of the stations 4 will be described later in detail.

The server 13 has a server control CPU 81 used as a calculation and controller unit for controlling the overall control of the server 13, a ROM 82, a RAM 83, a timer 84 connected to the server control CPU 81, a liquid crystal display 32 connected to the server control CPU 81 through a liquid crystal driving circuit 85, and a keyboard 33 (see FIG. 4), as basic components.

The server control CPU 81 performs various types of processes on the basis of input signals and the like supplied from the stations 4 and data and programs stored in the ROM 82 and the RAM 83 and transmits command signals to the stations 4 on the basis of the result of the processes, thereby controlling the stations 4 for progressing games. In addition, the server control CPU 81 performs input of the balls 27A and 27B and rotation of the wheels 22A and 22B by driving drive motors included in the first roulette board 3A and the second roulette board 3B and determines win numbers on which the ball drops by controlling win determination units 86A and 86B that determine the locations of drop of the balls. The server control CPU 81 determines whether the bet chips win the game on the basis of the acquired two win numbers obtained by the roulette boards 3A and 3B and bet information transmitted from the stations 4, thereby calculating the number of credits to be paid to the stations 4.

The ROM 82, for example, is implemented as a semiconductor memory or the like and stores a program for providing basic functions of the roulette gaming machine 1, a program for a lottery of a JP bonus game that is executed under a predetermined condition, an award multiplication factor (the number of credits paid out per chip for winning the game) for a roulette game, and a program for controlling the stations 4.

The RAM 83 temporarily stores chip bet information supplied from the stations 4, the win numbers of the first roulette board 3A and the second roulette board 3B determined by the sensor, the current amount of the JP that has been accumulated, result data of the processes performed by the server control CPU 81, and the like.

A timer 84 that measures a time is connected to the server control CPU 81. Time information output by the timer 84 is transmitted to the server control CPU 81, and the server control CPU 81 performs an operation for rotating the wheels 22A and 22B or input of the balls 27A and 27B, to be described later, on the basis of the time information transmitted from the timer 84.

The electronic display unit 5 (see FIG. 1) is connected to the server control CPU 81. The server control CPU 81 performs visual effects using lamps by controlling light emitting device such as LEDs and displays a predetermined text or the like on the electronic display unit 5. The server control CPU 81 displays the current amount of the JP that has been accumulated on the JP amount display section 15 of the electronic display unit 5.

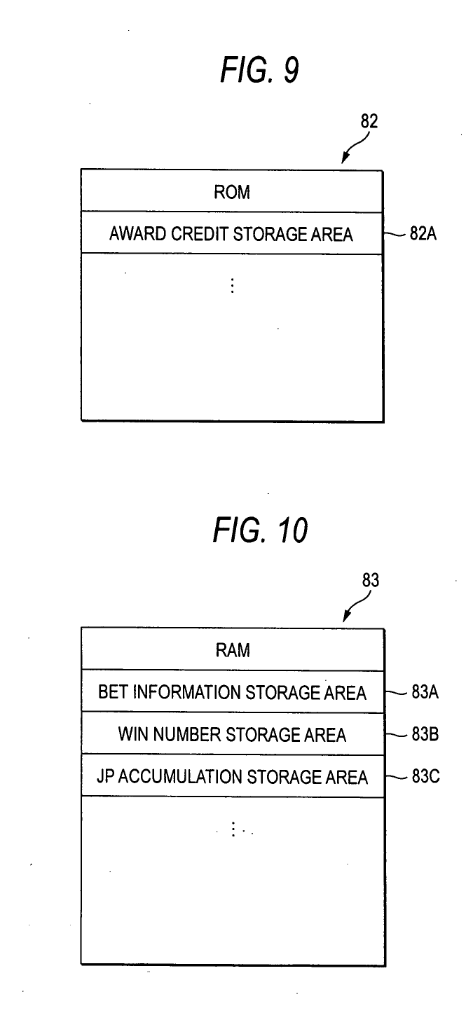

As shown in FIG. 9, in the ROM 82, there is provided an award credit storage area 82A, in which award multiplication factors for the roulette game using the BET screen 61 are stored. As the award multiplication factors for each BET area 72 of the BET screen 61 which are stored in the award credit storage area 82A, as shown in FIG. 6, multiplication factors in the range of 1 to 1296 are determined and stored in advance on the basis of the type of the bet method (the “straight bet”, the “corner bet”, the “split bet”, or the like) and the number of matched numbers.

As shown in FIG. 10, in the RAM 83, there are provided a bet information storage area 83A in which bet information of the player currently playing the game is stored, a win number storage area 83B in which the win numbers of the first roulette board 3A and the second roulette board 3B determined by the win determination units are stored, and a JP accumulation storage area 83C in which a pool amount, to which 0.5% of the number of credits bet on the BET screen 61 (see FIG. 5) has been pooled, is stored. The bet information is information on the bet performed using the station 4 such as the BET area 72 designated on the BET screen 61, the number of bet chips (number of bets), the type of the bet method, and the like.

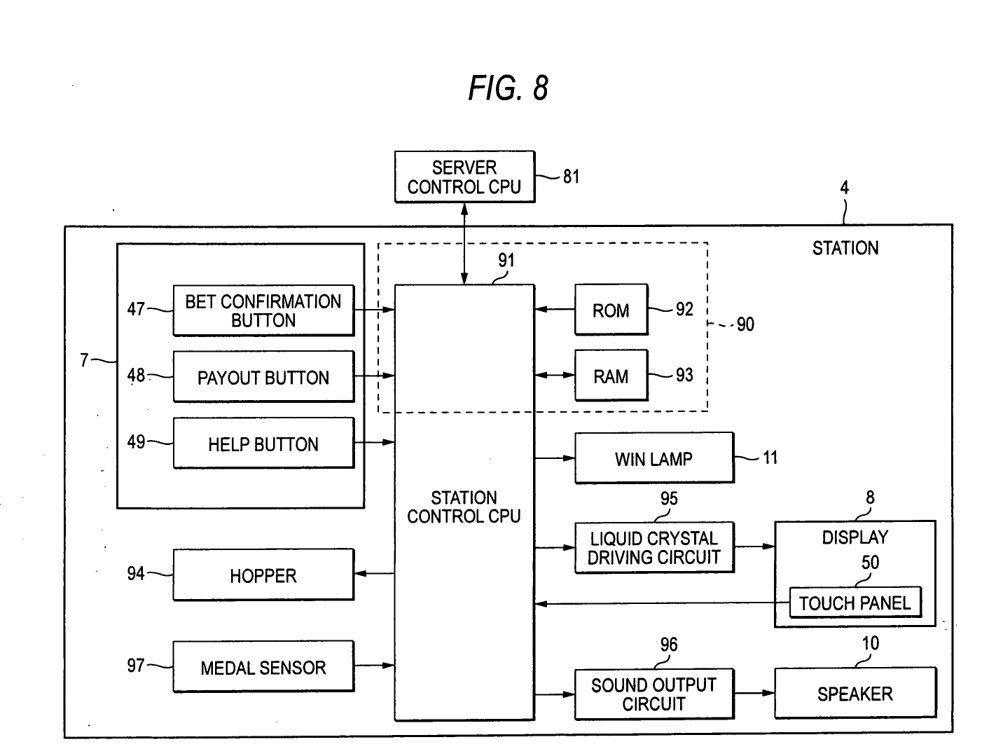

Next, the configuration of the control system of the station 4 connected to the server 13 according to the embodiment will be described with reference to FIG. 8. FIG. 8 is a block diagram schematically showing the control system of the station 4 according to the embodiment. Since each of the twelve stations 4 has the same configuration, hereinafter, one of the stations 4 will be described as an example.

As shown in FIG. 8, the station 4 includes a station controller unit 90 and several peripheral units. The station controller unit 90 includes a station control CPU 91, a ROM 92, and a RAM 93. The ROM 92, for example, is implemented as a semiconductor memory or the like and stores a program for providing basic functions of the station 4, other various programs required for controlling the station 4, a data table, and the like. The RAM 93 is a memory for temporarily storing various types of data calculated by the station control CPU 91, the current number of credits (stored in the station 4) owned by the player, a state of chip betting performed by the player, and the like.

The BET confirmation button 47, the payout button 48, and the help button 49 which are provided in the controller unit 7 (see FIG. 1) are connected to the station control CPU 91. The station control CPU 91 controls performing various appropriate operations on the basis of operation signals output by pressing the buttons or the like. In particular, the station control CPU 91 receives an input operation from the player, performs various processes on the basis of the input signal supplied from the controller unit 7 and data or a program which is stored in the ROM 92 or the RAM 93, and transmits the result to the above-described server control CPU 81.

The station control CPU 91 receives a command signal from the server control CPU 81, controls the peripheral units constituting the station 4, and progresses the roulette game in the station 4. The station control CPU 91, depending on the type of the process, receives an input operation from the player, performs various processes on the basis of the input signal supplied from the controller unit 7 and data or a program stored in the ROM 92 or the RAM 93, and controls the peripheral units constituting the station 4, thereby progressing the roulette game of the station 4.

A hopper 94 is connected to the station control CPU 91. The hopper 94 pays out a predetermined number of medals from the medal payout opening 9 (see FIG. 1) in accordance with the command signal transmitted from the station control CPU 91.

A display 8 is connected to the station control CPU 91 via a liquid crystal driving circuit 95. The liquid crystal driving circuit 95 is provided with a program ROM, an image ROM, an image control CPU, a work RAM, a VDP (video display processor), and a video RAM. The program ROM stores an image control program for display in the display 8 and various selection tables. In the image ROM, for example, dot data (bitmap data) for forming an image displayed by the display 8 is stored. The image control CPU determines an image to be displayed in the display 8, among dot data stored in the image ROM in advance, on the basis of the parameters set by the station control CPU 91 in accordance with an image control program stored in the program ROM in advance. The work RAM is configured as a temporary storage at a time when the image control program is executed in the image control CPU. The VDP forms an image on the basis of display determined by the image control CPU and outputs the image to the display 8. The video RAM is configured as a temporary storage at a time when an image is formed by the VDP.

On the front side of the display 8, a touch panel 50 is attached, and the operation information of the touch panel 50 is transmitted to the station control CPU 91. In the touch panel, a chip betting operation on the BET screen 61 is performed by the player. In particular, the touch panel 50 is operated in selecting the BET area 72, an operation of the unit BET buttons 66, or the like, and information on the operation of the touch panel 50 is transmitted to the station control CPU 91. On the basis of the information, the current bet information (the BET area designated on the BET screen 61 and the number of bet chips) of the player is occasionally stored in the RAM 93. The bet information is transmitted to the server control CPU 81 and stored in the bet information storage area of the RAM 83.

A sound output circuit 96 and a speaker 10 are connected to the station control CPU 91. The speaker 10 generates and outputs various types of sound effects on the basis of a signal output from the sound output circuit 96.

A medal sensor 97 is connected to the station control CPU 91. The medal sensor 97 detects medals inserted from the medal insertion slot 6 (see FIG. 1), counts the inserted medals, and transmits the result to the station control CPU 91. Then, the station control CPU 91 increases the number of credits owned by the player, which is stored in the RAM 93, on the basis of the transmitted signal.

A WIN lamp 11 is connected to the station control CPU 91. When the chips bet on the BET screen 61 wins the game or the player wins the JP, the station control CPU 91 turns on the WIN lamp 11 in a predetermined color.

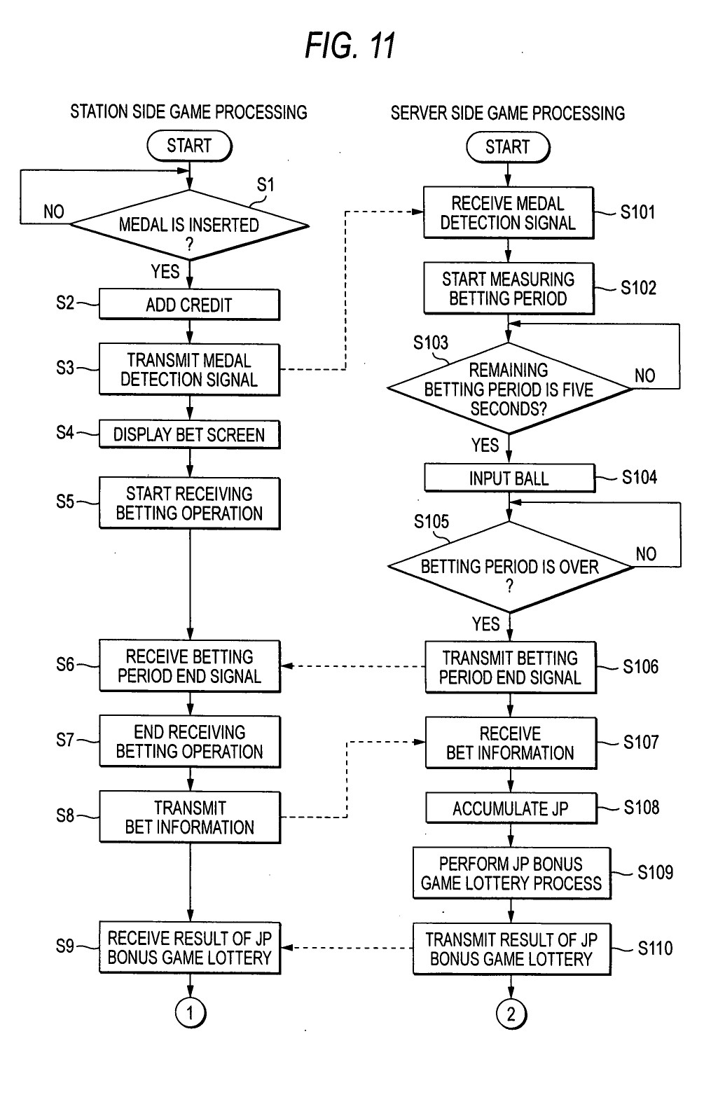

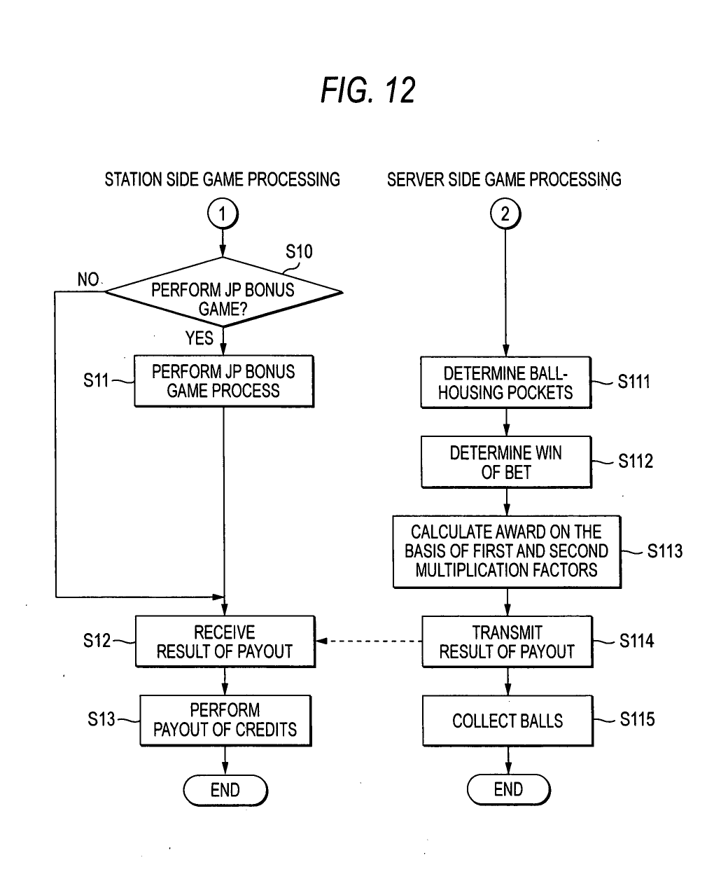

Subsequently, in the roulette gaming machine 1 according to the embodiment, a game processing program on the server side executed by the server control CPU 81 and a game processing program on the station 4 side executed by the station control CPU 91 will now be described with reference to FIGS. 11 and 12. The programs shown as flowcharts in FIGS. 11 and 12 are stored in the ROM 82 or RAM 83 included in the server 13 and the ROM 92 or RAM 93 included in the station 4 and are executed by the server control CPU 81 and the station control CPU 91.

First, the game processing program on the station side will be described with reference to FIGS. 11 and 12. First, in Step (hereinafter, abbreviated to as S) 1, the station control CPU 91 determines whether a medal or a coin is inserted by the player on the basis of a detection signal transmitted from the medal sensor 97. When there is no insertion of a medal or a coin (S1: NO), the process stands by until a medal or a coin is inserted. On the other hand, when a medal or a coin is inserted (S1: YES), the process proceeds to S2.

In S2, credit data corresponding to the number of inserted medals or coins is stored in the RAM 93.

Then, in S3, a medal insertion signal for indicating the insertion of the medal or the coin is transmitted to the server 13.

In S4, the BET screen 61 shown in FIG. 5 is displayed in the display 8 of the station 4, and a betting period in which the player can bet a chip is started (S5). Then, the player participating in the game can bet a chip in a BET area 72 corresponding to a number that the player predicts to win the game by operating the touch panel 50 during the betting period in which a bet can be received (see FIG. 5). Since the method of betting chips using the BET screen 61 has been described above, the description thereof is omitted here.

The player is allowed to join in a game while the game is under a state where the betting period is already started. In the roulette gaming machine 1 according to the embodiment, a maximum of 12 players are allowed to participate in the same game. When a game is performed following the previous game, the reception of the betting operation is started right after the previous game is over.

In S6, when receiving a betting period end signal directing the end of the betting period from the server control CPU 81, the display 8 of the station 4 displays an image indicating the end of the betting period, and the reception of a betting operation in the touch panel 50 ends (S7). Then, the station 4 transmits the information (the designated BET area 72 and the number of chips bet (the number of bets) in the designated BET area 72) on the betting operation performed by the player (S8).

In S9, the station control CPU 91 receives the result of a lottery process (S109) of a JP bonus game, to be described later, which is executed by the server control CPU 81, from the server 13. The result of a lottery process of a JP bonus game includes a lottery result of whether a JP bonus game is to be generated for each station 4 and a lottery result of whether any station 4 from among the twelve stations 4 will win the JP (or, none of the stations 4 will win the JP) in a state where the JP bonus game is to be generated.

Next, in S10 shown in FIG. 12, the station control CPU 91 determines whether to generate a JP bonus game on the basis of the result of the lottery process for generating a JP bonus game received in S9. When it is determined that the JP bonus game is to be not generated in the station 4 (S10: NO), the process proceeds to S12.

On the other hand, when it is determined that the bonus game is to be generated in the station 4 (S10: YES), a predetermined selection-type bonus game for acquisition of the JP is performed in S11, and the result of the game (whether the JP is acquired) is displayed in the display 8 on the basis of the lottery result received in S9.

In S12, the station control CPU 91 receives the result of credit payment from the server 13. The result of credit payment includes the result of payment in an ordinary roulette game that is performed using the BET screen 61 and the result of payment in the JP bonus game.

Thereafter in S13, payment of credits is performed on the basis of the payment result received in S12. In particular, credit data corresponding to an award in the roulette game that is an ordinary game and credit data corresponding to the current JP amount that has been accumulated, in a state where a JP bonus game has been generated and the station 4 has won the JP, are stored in the RAM 93.

Then, when the payout button 48 is pressed, medals (usually, one medal for each credit) corresponding to the current number of credits stored in the RAM 93 are paid out from the medal payout opening 9. Especially for the award of the roulette game, an award multiplication factor is determined on the basis of the number of matched numbers between the number bet in the BET screen 61 by the player and the win number (hereinafter, referred to as a first win number) detected by the first roulette board 3A and the win number (hereinafter, referred to as a second win number) detected by the second roulette board 3B, and the amount resulted from multiplying the bet amount by the multiplication factor becomes the award. As shown in FIG. 6, a multiplication factor (a second multiplication factor) for a case where the bet number matches both the first win number and the second win number is set to be larger than a multiplication factor (a first multiplication factor) for a case where the bet number matches one between the first win number and the second win number.

Thereafter, when a game is played consecutively in any station 4, the process proceeds back to S4, and a betting period is started, thereby proceeding to the next game.

On the other end, when games in all the stations 4 are over, the roulette game process ends.

Next, the game processing program on the server side will be described with reference to FIGS. 12 and 13. In S101, the server control CPU 81 receives a medal detection signal transmitted from the station control CPU 91 in S3 and determines whether the player has inserted a medal or a coin. In the roulette gaming machine 1 according to the embodiment, when a medal or a coin is inserted into any one of the stations 4, a medal insertion signal is transmitted from the station control CPU 91 of the station 4 into which the medal or coin has been inserted to the server control CPU 81.

Then, measuring of a betting period during which a player can place a bet is started from a time point when a firstly participating player inserts the medal or the coin (S102). When a game is played following the previous game, the betting period is started right after the previous game is over. A player participating in the game can bet his or her chips on the BET area 72 corresponding to a number that he predicts to win the game by operating the touch panel 50 during the betting period.

Next, in S103, it is determined whether the remaining betting period is 5 seconds. In addition, the remaining betting period is displayed in the display 8 by the BET time display unit 69 (see FIG. 5). When it is determined that the remaining betting period does not reach 5 seconds (S103: NO), the process stands by until the remaining betting period becomes 5 seconds. When it is determined that the remaining betting period has reached 5 seconds (S103: YES), a lottery process by using the first and the second roulette boards 3A and 3B is performed in accordance with the game execution program, as described below.

First, the ball discharge unit is driven so as to input the balls 27A and 27B inside the wheels 22A and 22B (S104). In addition, driving motors are driven so as to rotate the wheels 22A and 22B at a predetermined rotation speed in a direction opposite to the ball input direction. The input balls 27A and 27B roll on the roulette wheels along the guide walls 29A and 29B. Then, as the rotation speed of the wheels reduces and the centrifugal forces decrease, the balls roll down the slopes of the frame bodies 21A and 21B, move inward, and arrive on the center portions of the rotating wheels 22A and 22B (see FIG. 2).

Then, the balls 27A and 27B that have rolled to the wheels 22A and 22B pass through the number indication plates 25A and 25B disposed in outer portions of the rotating wheels 22A and 22B and are housed in each one of the number pockets 23A and 23B. Thus, a number (in FIG. 2, any one of “00”, “0”, and “1” to “36”) marked on the number indication plate 25A corresponding to the number pocket 23A housing the ball 27A becomes the first win number. In addition, a number marked on the number indication plate 25B corresponding to the number pocket 23B housing the ball 27B becomes the second win number.

In S105, it is determined whether the betting period is over. When the betting period is not over (S105: NO), the process stands by until the betting period is over. When it is determined that the betting period is over (S105: YES), a betting period end signal indicating the end of the betting period is transmitted to the station control CPU 91 in S106.

In S107, bet information (the designated BET area 72, the number of chips (the number of bets) bet on the designated area 72, and the bet method) on the betting operation performed by the player for each station 4 is received and is stored in the bet information storage area 83A of the RAM 83.

In S108, credits corresponding to 0.5% of total credits bet in the stations 4 which are received in S107 are added to the amount of the JP recorded in the JP accumulation storage area 83C of the RAM 83. In accompaniment with the adding operation, display of the JP amount display section 15 and the JP display unit 73 is updated.

Next, in S109, the server control CPU 81 acquires a random number from a random number sampling circuit or the like, and a lottery for determining whether to generate a JP bonus game for each station 4 and whether any station 4 will win the JP (or none of the stations 4 will win the JP) is performed.

Subsequently, in S110, the result of the lottery for the JP bonus game for each station 4 is transmitted to the stations 4 on the basis of the lottery process of S109.

In S111, after the balls 27A and 27B are housed in the number pockets 23A and 23B, the server control CPU 81 drives the win determination units 86A and 86B so as to determine numbers corresponding to the number pockets 23A and 23B in which the balls 27A and 27B are housed. As a result, the first win number of the first roulette board 3A and the second win number of the second roulette board 3B for the game are detected.

In S112, the server control CPU 81 determines whether bet chips in each station 4 have won the game, that is, whether the numbers bet by the players and the first win number detected by the first roulette board 3A and the second win number detected by the second roulette board 3B are matched to each other on the basis of the bet information of the stations 4 received in S107 and the first and second win numbers detected in S111.

Subsequently, the server control CPU 81 performs an award calculation process (S113). In the award calculation process, the chips bet on the win number are recognized for each station 4 and the total amount of award credits to be paid to each station 4 is calculated using the award multiplication factor (the number of credits paid for each chip (each bet)) for each BET area 72 stored in the award credit storage area 82A of the ROM 82. In addition, as shown in FIG. 6, a multiplication factor (a first multiplication factor) for a case where the bet number matches one between the first win number and the second win number and a multiplication factor (a second multiplication factor) for a case where the bet number matches both the first win number and the second win number are different from each other, and the second multiplication factor is set to be larger than the first multiplication factor.

Then, in S114, the server control CPU 81 transmits the result of payout of credits for the roulette game on the basis of the award calculation process of S113 and the result of payout of the JP on the basis of the determination of winning a JP bonus game of S109. In particular, credit data corresponding to the amount of the award of the roulette game is output to the station control CPU 91 of the station 4 that has won the roulette game, and credit data corresponding to the pool amount currently pooled in the JP accumulation storage area 83C is additionally output in a state where the JP has been won.

In S115, the balls 27A and 27B on the wheels 22A and 22B are collected by driving the ball collection units provided below the wheels 22A and 22B. The collected balls 27A and 27B are input inside the wheels 22A and 22B of the roulette boards 3A and 3B again for the next game and thereafter.

As described above, in the roulette gaming machine 1 and the gaming manner of a roulette game according to the embodiment, it is determined whether the number bet by the player and the first and second win numbers detected by the first and second roulette boards 3A and 3B are matched to each other on the basis of the result of lotteries of win numbers performed using the first and second roulette boards 3A and 3B including a plurality of wheels 22A and 22B (S112), and when they are matched to each other, an amount resulted from multiplying the bet amount by the win multiplication factor that is set on the basis of the number of matched numbers is provided as an award (S113). Accordingly, it is possible to provide an award that is determined in consideration with a combination of the results of games using two roulette boards, while the known configuration of the wheel and lottery method are used. Thus, the condition for wining an award or details of awards can be changed in various ways, and accordingly, it is possible to prevent the player from being tired of the game. In addition, since the rank of awards is determined using win numbers detected by two wheels 22A and 22B and a high-value award is provided in a state where a high ranking award is won, it is possible to provide a high-value award that cannot be easily implemented by using a known roulette game.

In addition, as the number of matched numbers increases, an amount resulted from multiplying the bet amount by a large multiplication factor is provided as an award, and accordingly, it is possible to gradationally change the details of awards on the basis of matching the win numbers drawn in the plurality of wheels 22A and 22B.

The present invention is not limited to the above-described embodiment, and it is apparent that various changes and modifications may be made therein without departing from the scope of the present invention.

For example, in the embodiment, as shown in FIG. 6, although an award of which amount is calculated by multiplying the bet amount by a predetermined multiplication factor is given when the bet number is matched to at least one between the first and second win numbers, however, it may be configured that the award is provided only when the bet number matches both the win numbers and an award is not given when the bet number is matched only to one win number. In addition, the ordinary bet table shown in FIG. 5 may be replaced with a bet table in which a “double 12” and the like for providing higher awards are included.

In the embodiment, although the roulette gaming machine 1 has the first roulette board 3A and the second roulette board 3B all the time, only one roulette board may be provided normally and a second roulette board may newly emerges in a state where a predetermined condition is satisfied. As the condition, for example, a condition in which the total number of bets for the station 4 is equal to or greater than a predetermined number of bets may be used.

What is claimed is:

1. A roulette gaming machine comprising:
a plurality of wheels that are provided with a plurality of number pockets having identification numbers assigned thereto;
a plurality of balls that roll on an upper face of each of the wheels to be housed into one of the number pockets, respectively;
a win number detecting unit that detects the identification numbers that are assigned to the number pockets into which the balls are housed as win numbers;
a betting unit that allows a player to input a betting operation for performing a prediction of the win numbers as bet numbers; and
a controller that operates to:
determine a number of match between the bet numbers and the win numbers;
determine a multiplication factor based on the number of match; and
provide an award to the player when the number of match is larger than zero, the award having an amount calculated by multiplying a bet amount by the multiplication factor.

2. The roulette gaming machine according to claim 1, wherein the controller determines the multiplication factor to be larger as the number of match increases.

3. A roulette gaming machine comprising:
a first wheel that is provided with a plurality of number pockets having identification numbers assigned thereto;
a second wheel that is provided with a plurality of number pockets having identification numbers assigned thereto;
a first ball that rolls on an upper face of the first wheel to be housed into one of the number pockets;
a second ball that rolls on an upper face of the second wheel to be housed into one of the number pockets;
a first win number detecting unit that detects the identification number that is assigned to the number pockets into which the first ball is housed as a first win number;
a second win number detecting unit that detects the identification number that is assigned to the number pockets into which the second ball is housed as a second win number;
a betting unit that allows a player to input a betting operation for performing a prediction of the first win number and the second win numbers as bet numbers; and
a controller that operates to:
determine that a first win is satisfied when one of the bet numbers matches with one of the first win number and the second win number;
provide an award to the player when determined that the first win is satisfied, the award having an amount calculated by multiplying a bet amount by a first multiplication factor;
determine that a second win is satisfied when the bet numbers match with both of the first win number and the second win number; and
provide an award to the player when determined that the second win is satisfied, the award having an amount calculated by multiplying the bet amount by a second multiplication factor that is larger than the first multiplication factor.

4. A method for providing a roulette game to a player, the method comprising:
determining identification numbers for each of a plurality of wheels respectively, as win numbers, from among a plurality of identification numbers assigned to a plurality of number pockets provided on the wheels;
allowing the player to input a betting operation for performing a prediction of the win numbers as bet numbers;
determining a number of match between the bet numbers and the win numbers;
determining a multiplication factor based on the number of match; and
providing an award to the player when the number of match is larger than zero, the award having an amount calculated by multiplying a bet amount by the multiplication factor.

5. The method according to claim 4, wherein the multiplication factor is determined to be larger as the number of match increases.

6. A method for providing a roulette game, the method comprising:
determining an identification number, as a first win number, from among a plurality of identification numbers assigned to a plurality of number pockets provided on a first wheel;
determining an identification number, as a second win number, from among a plurality of identification numbers assigned to a plurality of number pockets provided on a second wheel;
allowing the player to input a betting operation for performing a prediction of the first win number and the second win number as bet numbers;
determine that a first win is satisfied when one of the bet numbers matches with one of the first win number and the second win number;
provide an award to the player when determined that the first win is satisfied, the award having an amount calculated by multiplying a bet amount by a first multiplication factor;
determine that a second win is satisfied when the bet numbers match with both of the first win number and the second win number; and
provide an award to the player when determined that the second win is satisfied, the award having an amount calculated by multiplying the bet amount by a second multiplication factor that is larger than the first multiplication factor.
